(19) United States
(12) Patent Application Publication
(10) Pub. No.: US 2024/0345349 A1
(43) Pub. Date: Oct. 17, 2024

(54) OPTIMIZED LOW FIBER COUNT STRANDED LOOSE TUBE FIBER CABLE

(71) Applicant: CommScope Technologies LLC, Claremont, NC (US)

(72) Inventors: Larry L. Bleich, Hickory, NC (US); David A. Wiebelhaus, Hickory, NC (US); Jason N. Morrow, Taylorsville, NC (US); Nathan S. Hatch, Claremont, NC (US)

(21) Appl. No.: 18/749,389

(22) Filed: Jun. 20, 2024

Related U.S. Application Data
(63) Continuation-in-part of application No. PCT/US2023/026173, filed on Jun. 24, 2023.
(60) Provisional application No. 63/472,807, filed on Jun. 13, 2023.
(60) Provisional application No. 63/429,129, filed on Nov. 30, 2022.
(60) Provisional application No. 63/389,191, filed on Jul. 14, 2022.

(51) Int. Cl. G02B 6/44

(52) U.S. Cl. CPC G02B 6/4431; G02B 6/44384

(57) ABSTRACT

An optical cable with one or two buffer tubes and one or more strength members, such as one or more glass reinforced plastic (GRP) members, has an outer jacket with an outer surface with a substantially circular cross section. In a preferred embodiment, two strength members are stranded along with one buffer tube and the outer jacket has a substantially circular cross section with plural valleys and ridges formed on the outer surface thereof. In another embodiment, a centrally located strength member is twisted itself, during the initial manufacturing of the strength member. In another embodiment, a centrally located strength member includes an external feature formed in a twisted manner, either in a helical or S-Z manner, during the initial manufacturing of the strength member, to match the clocking of the stranded buffer tubes abutting the central strength member when the cable is later assembled.

This application is a continuation-in-part of International Application No. PCT/US2023/026173, filed Jun. 24, 2023, which claims the benefit of U.S. Provisional Application No. 63/472,807, filed Jun. 13, 2023 and U.S. Provisional Application No. 63/429,129, filed Nov. 30, 2022 and U.S. Provisional Application No. 63/389,191, filed Jul. 14, 2022, all of which are herein incorporated by reference.

### BACKGROUND OF THE INVENTION

### 1. Field of the Invention

The present invention relates to a communications cable. More particularly, the present invention relates to an optical cable with one or two buffer tubes and one or more strength members, such as one or more fiber reinforced plastic (FRP) members, wherein the one or more strength members are stranded along with the one or more buffer tubes to produce a small diameter cable.

### 2. Description of the Background

FIG. 1A depicts a cable 20 in accordance with the prior art, shown in U.S. Pat. No. 8,165,439, which is herein incorporated by reference. The cable 20 includes six buffer tubes 21, each of which contains a plurality of optical fibers 22, e.g., up to six optical fibers 22. One or more of the buffer tubes 21 may be replaced by a filler, e.g., a solid rod formed of a dielectric material having a same diameter as a buffer tube 21, if a cable 20 with a lower fiber count is needed.

The buffer tubes 21 are stranded about a central strength member 23, e.g., a glass reinforced plastic (GRP) rod, wherein fibers to enhance strength are distributed through a rigid plastic rod. The central strength member 23 provides mechanical strength to a length of the cable 20, e.g., in a drop cable deployment, and also provides a good anchoring point for a connector at a cable termination.

Typically, the buffer tubes 21 and any filler rods are stranded about the central strength member 23 in a helical, or alternatively a S-Z, stranding pattern. As best seen in FIG. 1B, in a S-Z stranding pattern the buffer tubes 21 twist about the central strength member 23 for several revolutions in a clockwise direction, e.g., five to seven revolutions, then reverse direction at a first switchback 27 and twist about the central strength member 23 for several revolutions in a counter-clockwise direction, e.g., five to seven revolutions, to a second switchback 29. A pattern of clockwise rotations in zones A and counterclockwise rotations in zones B repeats along the length of the cable 20 between first, second, third, fourth, . . . switchbacks 27, 29, 31, 33, etc.

The central strength member 23 is “centrally” positioned within a cable jacket 24 and is not stranded, i.e., the central strength member 23 does not relocate its position within the jacket 24 either helically or in a S-Z pattern, as do the other members of the cable core. Further, the central strength member 23 is not twisted about its central axis. In other words, nothing in the cable manufacturing process imparts a twist to the central strength member 23 about its central axis and no feature of the central strength member 23 exhibits a twisted appearance, as such a twist would produce no known benefit since the central strength member 23 is a cylindrical rod.

During manufacturing, the central strength member 23 is paid off a reel and fed into a position, which will become the center of a cable core and hence the center of the overall cable 20. The buffer tubes 21 are stranded about the central strength member 23, and one or two binders 35 and 37 are wrapped about the buffer tubes 21, and any filler rods, to keep the cable core intact as the cable core is further processed during manufacturing.

Next, an additional layer 25, such as an armor layer, a shielding layer, a water blocking tape, and/or a layer of aramid, polyester, or flexible fiberglass yarns is applied around the cable core. The additional layer 25 surrounds the cable core. Finally, the cable jacket 24 is extruded around the additional layer 25 to form the optical cable 20. Ripcords 26 may optionally be positioned within the cable 20 to facilitate opening of the cable jacket 24 and additional layer 25 to permit access to the cable core.

Other configurations of optical cables with buffer tubes surrounding a central strength member are generally known in the prior art. For example, see U.S. Pat. Nos. 8,380,029; 10,191,237; 10,310,192; 10,649,163 and 11,095,103, and US Published Application 2004/0120664, each of which is herein incorporated by reference.

### SUMMARY OF THE INVENTION

The applicant has appreciated drawbacks with the designs of the optical cables of the prior art.

The typical design of an optical cable 20, shown in the prior art discussed above, has a central strength member 23 and buffer tubes 21 stranded about the central strength member 23. This typical design results in an optical cable 20 wherein an outer surface of the cable jacket 24 has a desirable circular cross section. The ratio of buffer tubes 21 around the central strength member 23 is usually five-around-one, six-around-one or seven-around-one. The outermost radial surfaces of the buffer tubes 21 (distanced furthest away from the central strength member 23) provide supporting “contact surfaces” for the additional layer 25 which supports the cable jacket 24. The evenly spaced, multiple “contact surfaces” result in the circular outer surface of the cable jacket 24. Hence, the three primary purposes of the central strength member are (1) to supply the geometry considerations to allow the buffer tubes to abut and be equally spaced so that the outer jacket is circular, (2) to provide an anchoring member for a connector at a cable end termination, and (3) to provide mechanical strength to a span of the cable, e.g., in a drop cable deployment or when pulling the cable through a conduit.

It is an object of the present invention to provide an optical cable with a strength member which addresses the three primary purposes of the central strength member while reducing the overall diameter of the optical cable, while maintaining the tensile strength of the overall cable, and/or while showing an improved crush performance since the armor diameter is smaller.

It is an object of the present invention to provide an optical cable which avoids any five-around one, six-around-one, etc. configuration, such that the geometric considerations of a centrally located, central strength member are no longer needed.

It is an object of the present invention to provide an optical cable which is an improvement from an environmental (green) perspective in that the cable uses less materials to perform the same functions, and has a smaller footprint, which may be beneficial from a densification perspective especially when the cable is used in a conduit or a similar pathway, and may be beneficial from a wind and ice load perspective when the cable is used in an environmentally exposed situation.

It is an object of the present invention to provide an optical cable with one or two buffer tubes and one or more strength members, which still provides a substantially circular cross-sectional shape to an outer surface of the outer jacket.

In preferred embodiments, it is an object of the present invention to provide an optical cable wherein the strength member is stranded along with one or more buffer tubes about a central axis of the overall cable along a length of the optical cable.

In one embodiment, it is an object of the present invention to provide an optical cable with one buffer tube, one filler rod and one or more strength members, which still provides a substantially circular cross-sectional shape to an outer surface of the outer jacket.

In one embodiment, it is an object of the present invention to provide an optical cable with one buffer tube and two strength members stranded along with the one buffer tube, which still provides a substantially circular cross-sectional shape to an outer surface of the outer jacket.

In one embodiment, it is an object of the present invention to provide an optical cable with as outer surface of the outer jacket which facilitates blowing the optical cable into a conduit with ease and which has a tensile strength to allow the optical cable to be pulled through the conduit.

In one embodiment, it is an object of the present invention to provide an optical cable wherein the strength member twists about a central axis to clock the stranding of the one or more buffer tubes along a length of the optical cable.

In one embodiment, it is an object of the present invention to provide an optical cable with a tape between first and second buffer tubes (or between a first buffer tube and a filler rod), wherein the tape is twisted during a stranding process of the cable manufacturing process.

In one embodiment, it is an object of the present invention to provide an optical cable which uses a strength member including first and second pockets to receive a buffer tube or filler rod, wherein the pockets are formed to twist around a circumference of the strength member prior to the cable manufacturing process.

These and other objectives are accomplished by an optical cable with one or two buffer tubes and one or more strength members, such as one or more glass reinforced plastic (GRP) members. The optical cable has an outer jacket with an outer surface with a substantially circular cross section. In a first embodiment, the one or more strength members are stranded along with the one or two buffer tubes. In a second embodiment, a centrally located strength member is twisted itself, during the initial manufacturing of the strength member. In a third embodiment, a centrally located strength member includes an external feature formed in a twisted manner, either in a helical or S-Z manner, during the initial manufacturing of the strength member, to match the clocking of the stranded buffer tubes abutting the central strength member when the cable is later assembled.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

For a better understanding of the invention, and to show how the same may be carried into effect, reference will now be made, by way of example, to the accompanying drawings, in which:

FIG. 1A is an end view of a cable with six buffer tubes stranded around a central strength member, in accordance with the prior art;

FIG. 1B side view of the cable of FIG. 1A with a portion of an outer jacket removed to illustrate stranding of the buffer tubes within the cable;

FIG. 2 is an end view of a cable, in accordance with a first embodiment of the present invention;

FIG. 3 is a perspective view of a helical lay length of two strength elements and a buffer tube within the cable of FIG. 2;

FIG. 4 is an end view of a cable, in accordance with a second embodiment of the present invention;

FIG. 5 is a perspective view a helical lay length of a strength element and a buffer tube within the cable of FIG. 4;

FIG. 6 is an end view of a cable, in accordance with a modification to the first embodiment of the present invention;

FIG. 6A is a cross-sectional view and perspective view of the cable in FIG. 6 showing how the cable jacket may draw down between the strength elements and buffer tube to form helical peaks and valleys on an outer surface of the cable jacket;

FIG. 6B is a cross-sectional view and perspective view of the cable in FIG. 6 showing how the cable jacket may draw down on corrugated armor to produce annular ridges in addition to the helical peaks and valleys on the outer surface of the cable jacket;

FIG. 7 is an end view of a cable, in accordance with a modification to the second embodiment of the present invention;

FIG. 8 is an end view of a cable, in accordance with a third embodiment of the present invention;

FIG. 9 is an end view of a cable, in accordance with a fourth embodiment of the present invention;

FIG. 10 is an end view of a cable, in accordance with a further modification to the first embodiment of the present invention;

FIG. 11 is an end view of a cable, in accordance with a further modification to the second embodiment of the present invention;

FIG. 12 is an end view of a cable, in accordance with a modification to the third embodiment of the present invention;

FIG. 13 is an end view of a cable, in accordance with a first modification to the fourth embodiment of the present invention;

FIG. 14 is an end view of a cable, in accordance with a second modification to the fourth embodiment of the present invention;

FIG. 15 is an end view of a cable, in accordance with a third modification to the fourth embodiment of the present invention;

FIG. 16 is an end view of a cable, in accordance with a fifth embodiment of the present invention;

FIG. 17 is an end view of a cable, in accordance with a sixth embodiment of the present invention;

FIG. 18 is an end view of a cable, in accordance with a seventh embodiment of the present invention;

FIG. 19 is an end view of a cable, in accordance with a eighth embodiment of the present invention; and

FIG. 20 is an end view of a cable, in accordance with a ninth embodiment of the present invention.

### DETAILED DESCRIPTION OF EMBODIMENTS OF THE INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity. Broken lines illustrate optional features or operations unless specified otherwise.

The terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “lateral”, “left”, “right” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. The device may be otherwise oriented (rotated 90 degrees or at other orientations) and the descriptors of relative spatial relationships used herein interpreted accordingly.

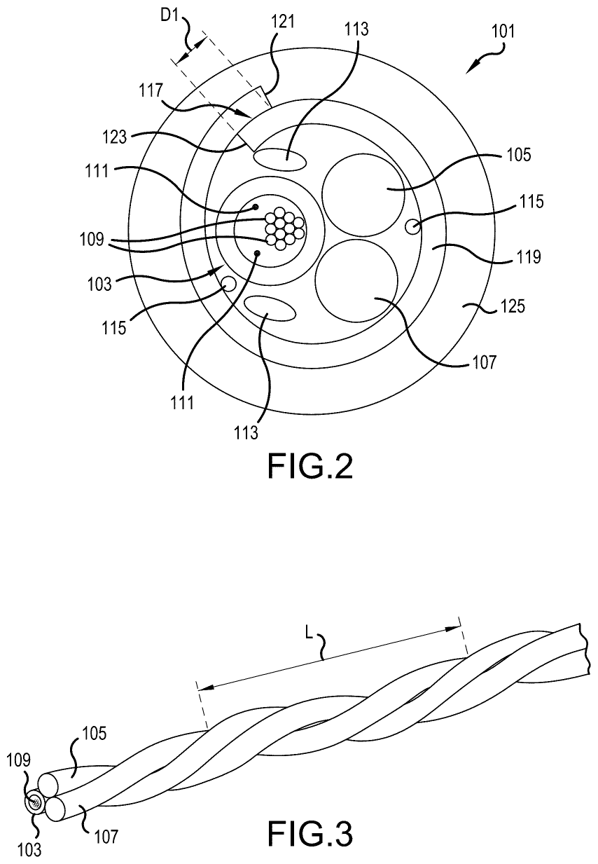

FIG. 2 depicts an end view of a first preferred cable 101, in accordance with the present invention. In FIG. 2, the core of the first preferred cable 101 includes a single, first buffer tube 103 stranded along with first and second strength members 105 and 107. The first buffer tube 103 has an outer diameter of about 2.5 mm, e.g., about 0.1 inches, although other sized buffer tubes may be used, such as a 2.0 mm buffer tube.

The first buffer tube 103 surrounds twelve optical fibers 109 and one or more ripcords 111. However, other numbers of optical fibers 109 and ripcords 111 may be surrounded by the first buffer tube 103. For example, when the first buffer tube 103 is sized at 2.5 mm and the optical fibers have a 200 micron diameter, the first buffer tube 103 may surround twenty four optical fibers 109 and one or more ripcords 111.

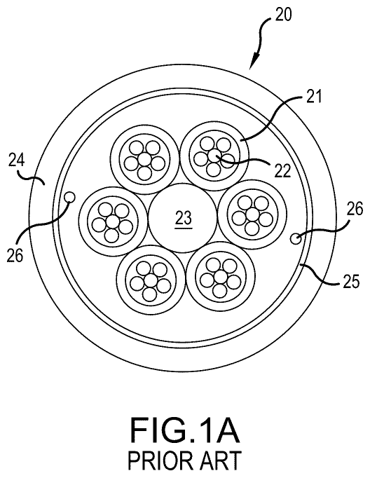

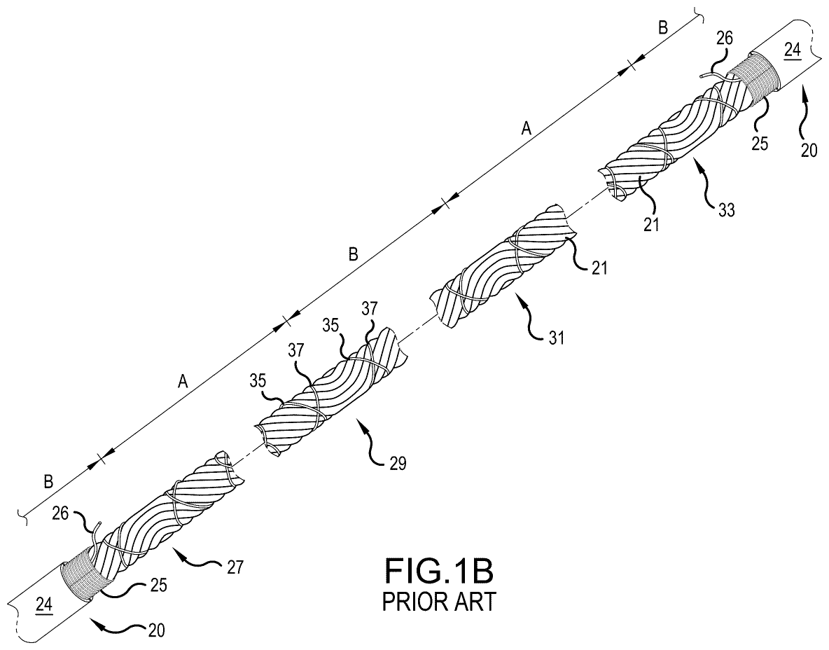

The first and second strength members 105 and 107 each have a diameter of about 2.5 mm, e.g., about 0.1 inches, although the diameter may be different, e.g., smaller or larger as shown in later embodiments. The first and second strength members 105 and 107 may each be formed as a fiber reinforced plastic (FRP) rod or other strong material. In all of the embodiments of the present invention, it is important to distinguish the difference between a strength member, like the typical central FRP rod, and a filler rod. In the prior art of FIG. 1A, the diameter of the central strength member 23 is about the same as the diameter of any filler rod (used to replace one of the buffer tubes 21). The diameter (size), the cross-sectional shape and the placement are not ways to distinguish a strength member from a filler rod.

The material used, and in particular the strength of the material used, is the best way to distinguish a strength member from a filler rod. The filler rod is used as a place holder. Therefore, it is cheaply formed and may be a constructed of a solid dielectric material. The tensile strength of a filler rod is much lower than a strength member, such as one or more orders lower for a same diameter. For example, in the cable designs of the present invention, the buffer tubes are about 2.5 mm in diameter. Therefore, the diameter of any filler rod in the present invention would match the diameter of the buffer tubes and be about 2.5 mm in diameter. A filler rod with a 2.5 mm diameter has a tensile strength of about 50 newtons (11.4 pounds).

Typical strength members are formed of a dielectric material with embedded reinforcement materials, e.g., short lengths of fiber, throughout the length of the strength member. The generic acronym FRP stands for “fiber reinforced polymer,” and can include a glass reinforced polymer (GRP), such as a fiber glass reinforced polymer. However, other types and lengths of fibers or reinforcement materials may be embedded within the dielectric material, e.g., polymer. For example, the embedded fibers or reinforcement materials may be formed of aramid fibers (sold under the trademark Kevlar®), bamboo fibers or shavings, nano tubes, animal hair, metal/alloy strands, etc. The embedded reinforcement materials add costs, weight and/or rigidity, all of which are undesirable in a filler rod. It may also be possible for the strength member to include or be formed of metal, such as stranded steel wires or a solid steel wire.

FRP strength members and steel wire strength members show much higher tensile strengths as compared to filler rods. For example, a 1 mm diameter GRP rod has a tensile strength of about 368 newtons (82 pounds), meaning the GRP rod does not break and has less than a 1% elongation when 368 newtons (82 pounds) of tensile force is applied thereto. A GRP rod with a 2.3 mm diameter has a 2,692 newton (600 pound) tensile strength. One manner to distinguish a filler rod from a strength member in the context of this application is therefore by a tensile strength. The tensile strength of the filler rod is well less than 50 pounds, such as less than 40 pounds or less than 30 pounds. Likewise, the tensile strength of the dielectric strength member with embedded reinforcement materials is greater than 30 pounds, such as greater than 40 pounds, and most preferably greater than 50 pounds. All of the strength members with circular cross-sectional shapes depicted in the Figures of the present invention will have a tensile strength greater than 70 pounds.

FIG. 3 is a perspective view of the cable core twist of the first buffer tube 103 stranded along with the first and second strength members 105 and 107 in FIG. 2, with the other cable elements removed. FIG. 3 illustrates a lay length L. In one embodiment, the lay length L is greater than 5 inches and less than 12 inches. For example, a lay length between 6 to 10 inches, more preferably about 7.5 to 8.0 inches, works well to keep the cable core intact during manufacturing. In a preferred embodiment, the lay length L may be 12 to 24 inches. For example, the lay length L may be about 15 to 20 inches, which will make a midspan access easier. S-Z stranding would also make a midspan access easier. However, S-Z stranding is not preferred because S-Z stranding requires one or more binders to be applied to the cable core during manufacturing. The helical stranding of FIG. 3 shows a consistent rotation direction. Therefore, binders are not needed to keep the cable core together during the manufacturing process.

Of particular note is that first and second strength members 105 and 107 may be formed in the same manner as the “central” strength member 23 of FIG. 1A. This means that a commonly available “central” strength member may be used as the first and/or second strength members 105 and 107. However, as is clear in FIGS. 2 and 3 and several of the other embodiments of the present invention, the first and second strength members 105 and 107 are not located “centrally” within the cable core, i.e., a central axis of the strength member 105 or 107 is not overlying a central axis of the overall optical cable 101. Rather, the first and second strength members 105 and 107 are parts of the stranded core elements and would follow a helical path along a length of the optical cable 101.

As shown in FIG. 2, the cable core may further include one or more e-glass strength members 113 (two e-glass strength members 113 are shown in FIG. 2). The e-glass members 113 typically have a cross-sectional shape in an oval or rectangular shape and may be placed alongside a stranded cable core or may be stranded along with the cable core elements in the interstices of the first buffer tube 103 and the first and second strength members 105 and 107.

The embodiment of FIG. 2 also includes two ripcords 115. The ripcords 115 are not part of the stranded core. Therefore, the ripcords 115 do not spiral in a helical pattern, but rather stay in a same placement relative to an overlap 117 in an armor layer 119. A thickness of the armor layer 119 and the overlap 117 has been exaggerated in FIG. 2. It is preferred that no ripcord 115 be placed at the overlap 117 of the armor layer 119 because it is very difficult to tear through two layers of the armor layer 119 with a ripcord 115, and/or the ripcord 115 may break when attempting to pull it through the overlap 117 of the armor layer 119. To keep the ripcords 115 properly positioned relative to the armor layer 119, the ripcords 115 may be adhered to an inner surface of the armor layer 119.

The ripcords 115 are positioned about 180 degrees apart, so that the cable core can be easily separated from the ripped open armor layer 119. In one embodiment, the ripcords 115 are formed of stranded aramid fibers. For example, each ripcord 115 may be formed of plural stranded aramid fibers, each aramid fiber having a diameter of about 1/1000 of an inch, such that an overall diameter of the stranded bundle of aramid fibers is about 20 to 40 thousandths of an inch, more preferably about 25 to 35 thousandth of an inch, such as about 30 to 32 thousandth of an inch. Larger or smaller diameter ripcords 115 may be possible and may be dependent upon the material being used to form the ripcords 115. For example, the ripcords 115 may have a larger diameter when being formed of polyester.

As previously mentioned, the cable core may be surrounded by the armor layer 119. The armor layer 119 is typically corrugated to improve its strength, bending, and crush resistance, or may be a non-corrugated, smooth tape if added crush resistance is not needed. The width of the armor layer 119 from a first end 121 to a second end 123 is about 12 mm to 30 mm, more preferably about 15 to 22 mm, such as about 18 mm or about 20 mm. Typically, the armor layer 119 is formed of a metal or alloy, such as steel, copper or aluminum, and a thickness of the armor layer 119 from the peaks to the valleys of the corrugations is about 0.007 to 0.012 inches. In a preferred embodiment, the overlap 117 has a dimension D1 of about 0.07 to 0.08 inches. Alternatively, the armor layer 119 may be continuously formed without an overlap 117 of an extruded polymer, such as polyvinylchloride (PVC), if a totally dielectric cable is desired, as will be shown in further embodiments of the present invention. A dielectric, armor layer 119 could also be formed of other polymers with a rigidity, or tear/puncture resistance, greater than the material used to form an outer jacket 125.

The outer jacket 125 has a substantially uniform thickness of about 0.045 to 0.055 inches, e.g., about 0.05 inches. An overall diameter of the outer jacket 125 is less than 0.45 inches, more preferably less than 0.40 inches, such as about 0.30 inches.

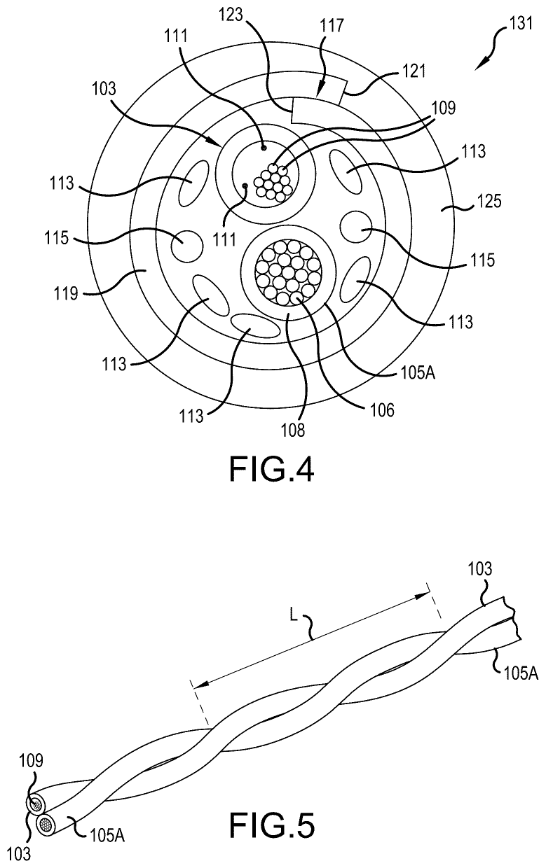

FIG. 4 depicts an end view of a second preferred cable 131. In FIG. 4, the core of the second preferred cable 131 includes a single, first buffer tube 103 stranded along with a single, first strength member 105A. The first buffer tube 103 has an outer diameter of about 2.5 mm, e.g., about 0.1 inches, although other sized buffer tubes may be used, such as a 1.0 mm to 2.0 mm diameter buffer tube.

The first buffer tube 103 surrounds twelve optical fibers 109 and one or more ripcords 111. However, other numbers of optical fibers 109 and ripcords 111 may be surrounded by the first buffer tube 103. For example, when the first buffer tube 103 is sized at 2.5 mm and the optical fibers have a 200 micron diameter, the first buffer tube 103 may surround twenty four optical fibers 109 and one or more ripcords 111.

The first strength member 105A has a diameter of about 2.5 mm, e.g., about 0.1 inches. In FIG. 4, the first strength member 105A is formed of plural stranded steel wires 106 surrounded by an optional polymer upjacket 108, although the first strength member 105A may be formed of the other materials described in connection with the embodiment of FIG. 2.

FIG. 5 is a perspective view of the core twist of the first buffer tube 103 stranded along with the first strength member 105A in FIG. 4, with the other cable elements removed. FIG. 5 illustrates a lay length L. The lay length L may be the same as the lay length L described in conjunction with FIG. 3.

As shown in FIG. 4, the cable core may further include one or more e-glass strength members 113 (five e-glass strength members 113 are shown in FIG. 4). The e-glass members 113 typically have a cross-sectional shape in an oval or rectangular shape and may be placed alongside a stranded cable core or may be stranded along with the cable core elements in the interstices of the first buffer tube 103 and the first strength member 105A.

The embodiment of FIG. 4 also includes two ripcords 115. The ripcords 115 are not part of the stranded core. The ripcords 115 may be formed of a same material as described in connection with the embodiment of FIG. 2. The armor layer 119 surrounds the cable core and is typically corrugated to improve its strength, bending, and crush resistance. The armor layer 119 may be formed of a same material, and with the same or similar dimensions, as described in connection with the embodiment of FIG. 2. The outer jacket 125 surrounds the armor layer 119 and may be formed of a same material, and with the same or similar dimensions, as described in connection with the embodiment of FIG. 2.

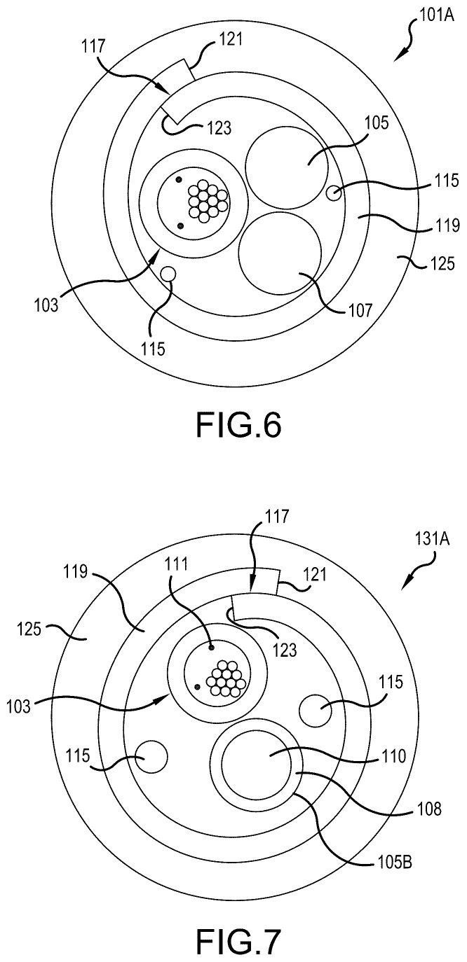

FIG. 6 is an end view of a modified, first preferred cable 101A, similar to FIG. 2, but without the e-glass strength members 113. Removing the e-glass strength members 113 from adjacent to the stranded cable core or the interstices between the first buffer tube 103 and the first and second strength members 105 and 107 can offer improvements in the flexibility and crush resistance of the first preferred cable 101, as will be further explained hereinafter, and lowers manufacturing costs. FIGS. 6A and 6B are cross-sectional views taken through the modified, first preferred cable 101A of FIG. 6, showing alternative surface configurations of the outer jacket 125 along a cable length CL of the modified, first preferred cable 101A.

FIG. 6A demonstrates how the extruded jacket 125 tends to flow into and shrink down into the interstices formed between the first buffer tube 103 and the first and second strength members 105 and 107. The process of extruding the jacket 125 onto the cable core tends to push the armor layer 119 into the interstices. However, the armor layer 119 may be initially seated more fully into the interstices, as the armor layer 119 is applied to surround the cable core, such as by a roller or guiding system. In the case of the modified, first preferred cable 101A, there are three interstices between the first buffer tube 103 and the first and second strength members 105 and 107, which leads to three valleys 221 and three peaks 223 formed on the outer surface of the jacket 125, where the peaks 223 overlie radially outmost portions of the first buffer tube 103 and the first and second strength members 105 and 107. Due to the helical stranding of the cable core, the three valleys 221 and three peaks 223 twist helically about the outer surface of the jacket 125 along the cable length CL of the first preferred cable 101A. FIG. 6A shows the outer surface of the cable jacket 125 when the armor layer 119 is a non-corrugated, smooth tape type of armor layer 119.

FIG. 6B also demonstrates how the jacket 125 tends to flow and shrink down into the interstices formed between the first buffer tube 103 and the first and second strength members 105 and 107 to form the three valleys 221 and three peaks 223. However, in FIG. 6B, the armor layer 119 is a corrugated armor layer 119, such as the armor layer 25 shown in FIG. 1B. A corrugated armor layer 119 has a series of annular recesses and ridges spaced along the cable length CL. The recesses and ridges can also be seen and/or felt on the outer surface of the jacket 125. For example, an annular series of ridges 225 can be seen in FIG. 6B with slight recesses existing between the ridges 225. The height of the ridges 225, relative to the recesses therebetween, is much smaller than the height of the peaks 223, relative to the valleys 221 therebetween.

The outer surface configuration of the jacket 125 offers numerous advantages. Often times, it is desirable to blow a cable into a conduit. The modified, first preferred cable 101A excels in this instance. There are several factors which affect how far a cable can be blown through a conduit having several bends or sweeps along the length of the conduit, e.g., ten, twenty, thirty, fifty, sixty and/or ninety degree bends or sweeps. One factor is the frictional coefficient of the cable jacket against the interior wall of the conduit. Another factor is the rigidity of the cable, e.g., how well a cable can navigate a bend or sweep. Another factor is the amount of push that the cable receives from the air pressure being used to blow the cable into the conduit.

The outer surface configuration of the jacket 125 depicted in FIG. 6A, and in particular FIG. 6B, has synergistic effects, which testing has shown enables the optical cable 101A to be blown much farther into a conduit, e.g., over 40% farther. The first effect is that the frictional resistance of the optical cable 101A against the inner wall of the conduit is greatly reduced by the peaks 223 and ridges 225. If the outer surface of the jacket 125 were smooth, e.g., flat, as with a traditional cable, more jacket material would be in contact with the inner wall of the conduit and more contact friction would result. With the optical cable 101A of the present invention, there are fewer points of contact, or “touch points,” with the inner wall of the conduit. The optical cable 101A can only contact the inner wall of the conduit proximate the three peaks 223 and only contact the inner wall of the conduit at the ridges 225 along those peaks 223. This arrangement lowers the coefficient of friction during installation. Also, it is believed that the air stream used to push the optical cable 101A of the present invention through the conduit engages the peaks 223 and ridges 225 to increase the pushing force applied to the optical cable 101A like a sail. A traditional optical cable with a smooth surface on the outer wall of the jacket, would not have any “sail-like” features to capture the air stream and enhance the pushing force of the air stream against the traditional optical cable.

As previously mentioned, a corrugated armor layer 119 is more flexible as compared to a non-corrugated, smooth tape type of armor layer 119. It is believed that the helical valleys 221, which are almost parallel to the cable length CL, in combination with the ridges 225, which are almost perpendicular to the cable length CL, cause the jacket 125 to be more flexible in the same way that corrugating the armor layer 119 causes the armor layer 119 to be more flexible. A more flexible jacket 125 is advantageous to getting the optical cable 101A to navigate the bends and sweeps within the conduit.

Also, a traditional optical cable has a large “centrally located” strength element, e.g., GRP rod. The present optical cable 101A has two smaller strength elements 105 and 107, e.g., GRP rods, which are helically stranded. This displaces the strength elements 105 and 107, e.g., GRP rods, of the optical cable 101A from the center of the optical cable 101A like a corkscrew, which enables the optical cable 101A to be more flexible in navigating the bends and sweeps of the conduit. With a traditional optical cable, the centrally located GRP is always approaching a ninety degree bend or sweep perpendicularly and must be diverted ninety degrees by the bend or sweep to continue along within the conduit. With the optical cable 101A of the present invention, the strength elements 105 and 107 are always in a corkscrew orientation as they are helically stranded. Thus, when the optical cable 101A encounters a ninety degree bend or sweep the strength elements 105 and 107 are already slightly bent away from a perpendicular encounter, which it is believed facilitates a more natural ability of the optical cable 101A to be diverted by the bend or sweep.

The optical cable 101A of the present invention has an armor layer 119, yet it is able to be blown further through a conduit as compared to a similar, non-armored optical cable having a central strength member and a smooth outer surface on the jacket. This is because the armored, optical cable 101A of the present invention does not act or perform like a stiff armored cable during the blowing operation. It shows the flexibility of a non-armorer optical cable. Nonetheless, the armor layer 119 provides two advantages over the traditional, non-armored optical cable. The armoring layer 119 can be used as a toning conductor to locate the optical cable 101A in a buried conduit. This eliminates the cost of adding a toning wire to a traditional, non-armored optical cable. Also, the armor layer 119 provides a pull/tensile rated optical cable 101A, e.g., a 300 lb. tensile rating. This is an advantage if the optical cable 101A is needed to be removed from the conduit, since the cable will be pulled out of the conduit. The traditional, non-armored optical cable is non-pull rated and will be damaged if a pulling operation is used to pull it from a conduit.

FIG. 7 is an end view of a modified, second preferred cable 131A, similar to FIG. 4, but without the e-glass strength members 113. Removing the e-glass strength members 113 from adjacent to the stranded cable core or the interstices between the first buffer tube 103 and the first strength member 105A can offer improvements in the flexibility and crush resistance of the second preferred cable 131, as will be further explained hereinafter, and lowers manufacturing costs. FIG. 7 also illustrates how the first strength member 105A of FIG. 4 may alternatively be formed as a solid steel wire 110 surrounded by an optional polymer upjacket 108, although the first strength member 105B may be formed of the other materials described in connection with the embodiment of FIG. 2.

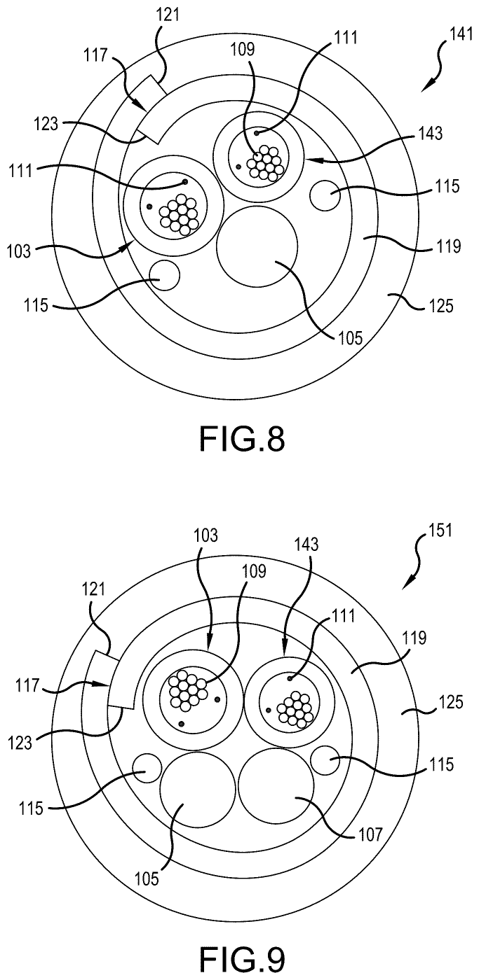

FIG. 8 depicts an end view of a third preferred cable 141. In FIG. 8, the core of the third preferred cable 141 includes a first buffer tube 103 and a second buffer tube 143 stranded along with a first strength member 105. Each of the first buffer tube 103 and the second buffer tube 143 has an outer diameter of about 2.5 mm, e.g., about 0.1 inches, although other sized buffer tubes may be used, such as 2.0 mm buffer tubes. As with the previous embodiments, each of the first and second buffer tubes 103 and 143 surrounds twelve optical fibers 109 and one or more ripcords 111. However, other numbers of optical fibers 109 and ripcords 111 may be surrounded by each of the first and second buffer tubes 103 and 143.

The first strength member 105 has a diameter of about 2.0 to 2.5 mm, e.g., about 0.078 to 0.1 inches. The first strength member 105 may be formed as described in relation to FIGS. 2-7 above, such as by a FRP rod, stranded metal wire or solid metal wire. The first strength member 105 may be helically stranded with the first and second buffer tubes 103 and 143. A lay length may be the same as the lay length L described in conjunction with FIG. 3.

The embodiment of FIG. 8 also includes two ripcords 115. The ripcords 115 are not part of the stranded core. The ripcords 115 may be formed of a same material as described in connection with the embodiment of FIG. 2. The armor layer 119 surrounds the cable core and is typically corrugated to improve its strength, bending, and crush resistance. The armor layer 119 may be formed of a same material, and with the same or similar dimensions, as described in connection with the embodiment of FIG. 2. The outer jacket 125 surrounds the armor layer 119 and may be formed of a same material, and with the same or similar thickness dimension, as described in connection with the embodiment of FIG. 2. With the embodiment of FIG. 8, an overall diameter of the outer jacket 125 is less than 0.5 inches, more preferably less than 0.45 inches, such as less than 0.43 inches, e.g., less than about 0.40 inches.

FIG. 9 depicts an end view of a fourth preferred cable 151. In FIG. 9, the core of the fourth preferred cable 151 includes a first buffer tube 103 and a second buffer tube 143 stranded along with a first strength member 105 and a second strength member 107. Each of the first buffer tube 103 and the second buffer tube 143 has an outer diameter of about 2.5 mm, e.g., about 0.1 inches, although other sized buffer tubes may be used, such as 2.0 mm buffer tubes. As with the previous embodiments, each of the first and second buffer tubes 103 and 143 surrounds twelve optical fibers 109 and one or more ripcords 111. However, other numbers of optical fibers 109 and ripcords 111 may be surrounded by each of the first and second buffer tubes 103 and 143.

Each of the first and second strength members 105 and 107 has a diameter of about 2.0 to 2.5 mm, e.g., about 0.078 to 0.1 inches. The first and second strength members 105 and 107 may be formed as described in relation to FIGS. 2-7 above, such as by a FRP rod, stranded metal wire or solid metal wire. The first and second strength members 105 and 107 are be helically stranded with the first and second buffer tubes 103 and 143. A lay length may be the same as the lay length L described in conjunction with FIG. 3.

The embodiment of FIG. 9 also includes two ripcords 115. The ripcords 115 are not part of the stranded core. The ripcords 115 may be formed of a same material as described in connection with the embodiment of FIG. 2. The armor layer 119 surrounds the cable core and is typically corrugated to improve its strength, bending, and crush resistance. The armor layer 119 may be formed of a same material, and with the same or similar dimensions, as described in connection with the embodiment of FIG. 2. The outer jacket 125 surrounds the armor layer 119 and may be formed of a same material, and with the same or similar thickness dimension, as described in connection with the embodiment of FIG. 2. With the embodiment of FIG. 9, an overall diameter of the outer jacket 125 is less than 0.5 inches, more preferably less than 0.45 inches, such as less than 0.43 inches, e.g., about 0.40 to 0.42 inches.

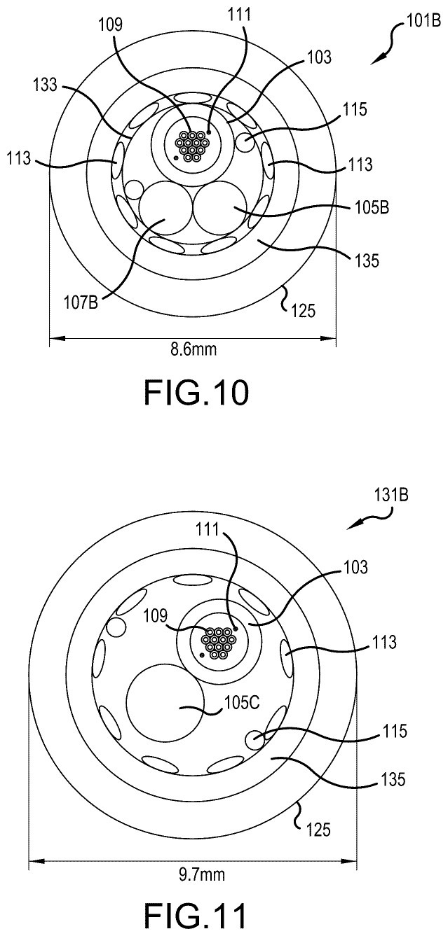

FIG. 10 is an end view of a further modified, first cable 101B, similar to FIGS. 2 and 6. In FIG. 10, the core of the further modified, first cable 101B includes the single, first buffer tube 103 stranded along with first and second strength members 105B and 107B. The first buffer tube 103 has an outer diameter of about 2.5 mm, e.g., about 0.1 inches, although other sized buffer tubes may be used, such as a 1.0 mm to 2.0 mm diameter buffer tube.

The first buffer tube 103 surrounds twelve optical fibers 109 and one or more ripcords 111. However, other numbers of optical fibers 109 and ripcords 111 may be surrounded by the first buffer tube 103. For example, when the first buffer tube 103 is sized at 2.5 mm and the optical fibers have a 200 micron diameter, the first buffer tube 103 may surround twenty four optical fibers 109 and one or more ripcords 111.

The first and second strength members 105B and 107B each have a smaller diameter as compared to FIGS. 2 and 6, such as about 1.6 mm, e.g., about 0.063 inches. In FIG. 10, the first and second strength members 105B and 107B are formed as FRP rods, e.g., GPR rods. The first and second strength members 105B and 107B are stranded along with the first buffer tube 103 with a lay length which may be the same as the lay length L described in conjunction with FIG. 3.

The cable core may further include one or more e-glass strength members 113 (nine e-glass strength members 113 are shown in FIG. 10). The e-glass members 113 typically have a cross-sectional shape in an oval or rectangular shape. In FIG. 10, the e-glass strength members 113 and may be placed on an outer surface of an optional core wrap 133, which may be formed of a paper or polymer. The e-glass strength members 113 are also in abutment with an inner surface of the armor layer 135. The embodiment of FIG. 10 also includes two ripcords 115 placed adjacent to an inner or outer surface of the optional core wrap 133. The ripcords 115 may be formed of a same material as the ripcords 115 discussed in the embodiments of FIGS. 2-9.

A notable distinction in FIG. 10 is that the armor layer 135 has no overlap, like overlap 117 in the embodiment of FIG. 2. The armor layer 135 is continuously formed of an extruded polymer, such as polyvinylchloride (PVC). Such an armor layer 135 is particularly useful if a totally dielectric cable is desired. The armor layer 135 could also be formed of other polymers with a rigidity, or tear/puncture resistance, greater than the material used to form an outer jacket 125. A thickness of the armor layer 135 may be similar to the thickness from the peaks to the valleys of the corrugated armor layer 119 of FIG. 2.

An outer jacket 125 surrounds the armor layer 135 and has a substantially uniform thickness of about 0.045 to 0.055 inches, e.g., about 0.05 inches. An overall diameter of the outer jacket 125 is less than 0.45 inches, more preferably less than 0.40 inches, such as less than 0.36 inches (9 mm or less).

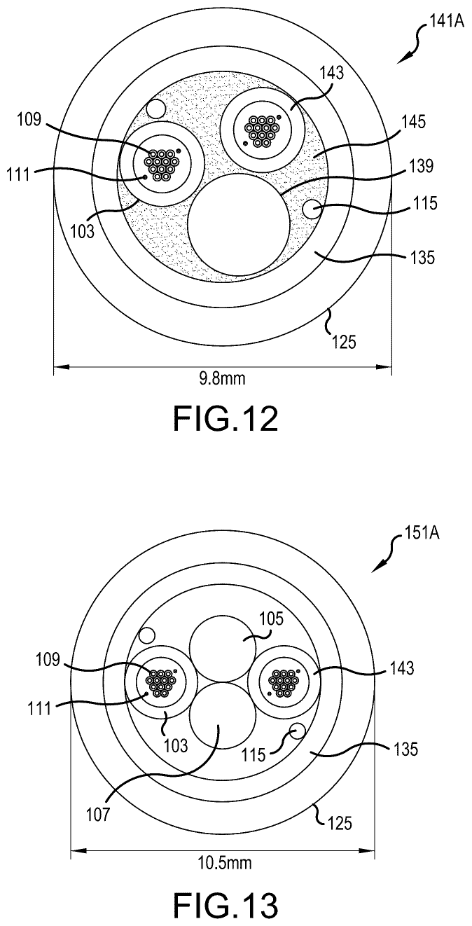

FIG. 11 is an end view of a further modified, second cable 131B, similar to FIGS. 4 and 7. In FIG. 11, the core of the further modified, second cable 131B includes the single, first buffer tube 103 stranded along with first strength member 105C. The first buffer tube 103 has an outer diameter of about 2.5 mm, e.g., about 0.1 inches, although other sized buffer tubes may be used, such as a 1.0 mm to 2.0 mm diameter buffer tube. The first buffer tube 103 surrounds twelve optical fibers 109 and one or more ripcords 111. However, other numbers of optical fibers 109 and ripcords 111 may be surrounded by the first buffer tube 103.

The first strength members 105C has a diameter approximately the same as the first buffer tube 103, such as about 2.5 mm, e.g., about 0.1 inches. In FIG. 11, the first strength member 105C is formed as a FRP rod, e.g., a GPR rod. The first strength member 105C is stranded along with the first buffer tube 103 with a lay length which may be the same as the lay length L described in conjunction with FIG. 5.

The cable core may further include one or more e-glass strength members 113 (nine e-glass strength members 113 are shown in FIG. 10). In FIG. 11, the e-glass strength members 113 abut with an inner surface of the armor layer 135. The embodiment of FIG. 11 also includes two ripcords 115 placed adjacent to the inner surface of the armor layer 135. The ripcords 115 may be formed of a same material as the ripcords 115 discussed in the embodiments of FIGS. 2-9.

A notable distinction in FIG. 11 is that the armor layer 135 has no overlap, like overlap 117 in the embodiment of FIG. 4. The armor layer 135 may be continuously formed of an extruded polymer, such as polyvinylchloride (PVC) in the same manner as described in connection with the embodiment of FIG. 10. The outer jacket 125 surrounds the armor layer 135 and has a substantially uniform thickness of about 0.045 to 0.055 inches, e.g., about 0.05 inches. An overall diameter of the outer jacket 125 is less than 0.45 inches, more preferably less than 0.40 inches (10 mm or less).

FIG. 12 is an end view of a modified, third cable 141A, similar to FIG. 8. In FIG. 12, the core of the modified, third cable 141A includes the first buffer tube 103 and the second buffer tube 143 stranded along with a strength member 139. Each of the first buffer tube 103 and the second buffer tube 143 has an outer diameter of about 2.5 mm, e.g., about 0.1 inches, although other sized buffer tubes may be used, such as 2.0 mm buffer tubes.

Each of the first and second buffer tubes 103 and 143 surrounds twelve optical fibers 109 and one or more ripcords 111. However, other numbers of optical fibers 109 and ripcords 111 may be surrounded by each of the first and second buffer tubes 103 and 143.

The strength member 139 has a diameter of about 2.3 mm or larger. The first strength member 105 may be formed as described in relation to FIGS. 2-9 above, such as by a FRP rod, e.g., as a GRP rod, as shown in FIG. 12. The strength member 139 may be helically stranded with the first and second buffer tubes 103 and 143. A lay length may be the same as the lay length L described in conjunction with FIG. 3.

The armor layer 135 may be continuously formed of an extruded polymer, such as polyvinylchloride (PVC) in the same manner as described in connection with the embodiment of FIG. 10. The outer jacket 125 surrounds the armor layer 135 and has a substantially uniform thickness of about 0.045 to 0.055 inches, e.g., about 0.05 inches. An overall diameter of the outer jacket 125 is less than 0.45 inches, more preferably less than 0.40 inches (10 mm or less).

A notable distinction in FIG. 12 is that the inside of the cable, within the armor layer 135, is flooded. The cable core is flooded with a water-blocking or water-absorbing gel 145. A viscous, water-blocking or water-absorbing gel 145 may be added to any of the embodiments of the present invention.

The outer jacket 125 surrounds the armor layer 135 and has a substantially uniform thickness of about 0.045 to 0.055 inches, e.g., about 0.05 inches. An overall diameter of the outer jacket 125 is less than 0.45 inches, more preferably less than 0.40 inches (10 mm or less).

FIG. 13 is an end view of a modified, fourth cable 151A, similar to FIG. 9. In FIG. 13, the core of the modified, fourth cable 151A includes the first buffer tube 103 and the second buffer tube 143 stranded along with the first and second strength members 105 and 107. Each of the first buffer tube 103 and the second buffer tube 143 has an outer diameter of about 2.5 mm, e.g., about 0.1 inches, although other sized buffer tubes may be used, such as 2.0 mm buffer tubes.

Each of the first and second buffer tubes 103 and 143 surrounds twelve optical fibers 109 and one or more ripcords 111. However, other numbers of optical fibers 109 and ripcords 111 may be surrounded by each of the first and second buffer tubes 103 and 143.

Each of the first and second strength members 105 and 107 has a diameter of about 2.3 mm, and may be formed as described in relation to FIGS. 2-9 above, such as by GRP rods. The first and second strength member 105 and 107 may be helically stranded with the first and second buffer tubes 103 and 143. A lay length may be the same as the lay length L described in conjunction with FIGS. 3 and 5. The armor layer 135 may be continuously formed of an extruded polymer, such as polyvinylchloride (PVC) in the same manner as described in connection with the embodiment of FIG. 10.

A notable distinction in FIG. 13 is that the first and second strength members 105 and 107 abut each other and separate the first buffer tube 103 from the second buffer tube 143. The outer jacket 125 surrounds the armor layer 135 and has a substantially uniform thickness of about 0.045 to 0.055 inches, e.g., about 0.05 inches. An overall diameter of the outer jacket 125 is less than 0.45 inches, more preferably less than 0.41 inches (10.5 mm or less).

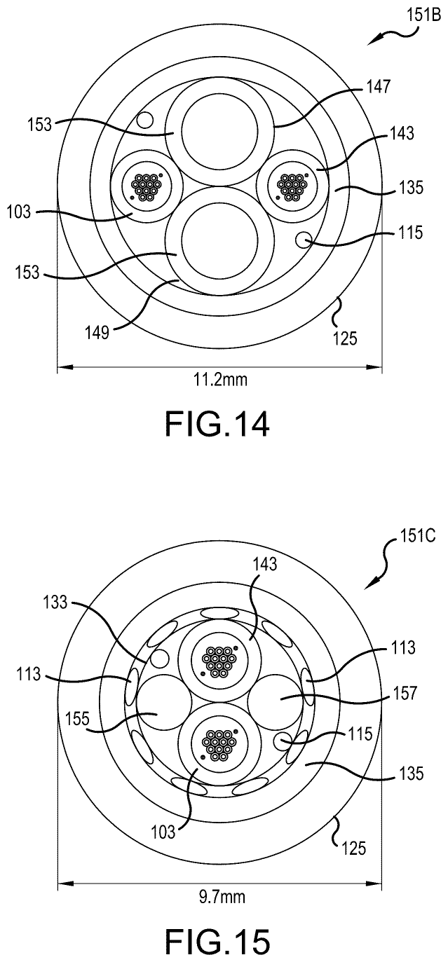

FIG. 14 is an end view of a cable 151B, similar to FIG. 13. The difference in FIG. 14 is that the first and second strength members 105 and 107 have been replaced by first and second strength members 147 and 149. Each of the first and second strength members 147 and 149 is formed by a GRP rod with a diameter of about 2.6 mm covered by a polymer upjacket 153 to bring the overall diameter of each of the first and second strength members 147 and 149 to about 3.75 mm. The armor layer 135 may be formed of PVC and surrounded by the outer jacket 125, as discussed in relation to FIG. 13.

FIG. 15 is an end view of a cable 151C, similar to FIG. 13. The differences in FIG. 15 are that the first and second strength members 105 and 107 have been replaced by first and second strength members 155 and 157. Each of the first and second strength members 155 and 157 is formed by a GRP rod with a diameter of about 1.6 mm. As second difference is that the first and second buffer tubes 103 and 143 abut each other and separate the first strength member 155 from the second strength member 157. A third difference is that the embodiment of FIG. 15 includes the core wrap 133 and the nine e-glass strength members 113 between the outer surface of the core wrap 133 and the inner surface of the armor layer 135.

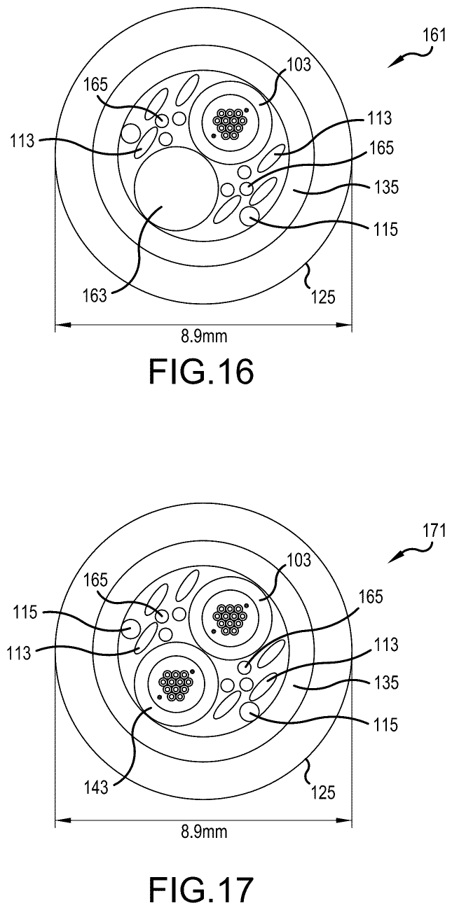

FIG. 16 depicts an end view of a fifth cable 161, in accordance with the present invention. The fifth cable 161 is similar to the embodiment of FIGS. 4 and 5 but does not include a strength member with a circular cross-sectional shape. The strength member 105A of FIG. 4 has been replaced by a filler rod 163, which as previously discussed and defined is much weaker than a strength member. While the fifth cable 161 may gain some tensile strength from the filler rod 163, the fifth cable 161 relies mainly upon a plurality of the e-glass strength members 113, such as six e-glass strength members 113, and fiber strength members (like aramid or polyester yarns) 165, both of which are stranded along with the first buffer tube 103 and the filler rod 163. The cable 161 of FIG. 16 might be suitable for short drops or situations where less pulling force is to be applied to the cable 161 during installation.

FIG. 17 depicts an end view of a sixth cable 171, in accordance with the present invention. The sixth cable 171 is also similar to the embodiment of FIGS. 4 and 5 but does not include a strength member with a circular cross-sectional shape. The strength member 105A of FIG. 4 has been replaced by the second buffer tube 143. The fifth cable 161 relies entirely upon a plurality of the e-glass strength members 113, such as six e-glass strength members 113, and fiber strength members (like aramid or polyester yarns) 165, both of which are stranded along with the first and second buffer tubes 103 and 143. The cable 171 of FIG. 17 might be suitable for short drops or situations where less pulling force is to be applied to the cable 16 during installation.

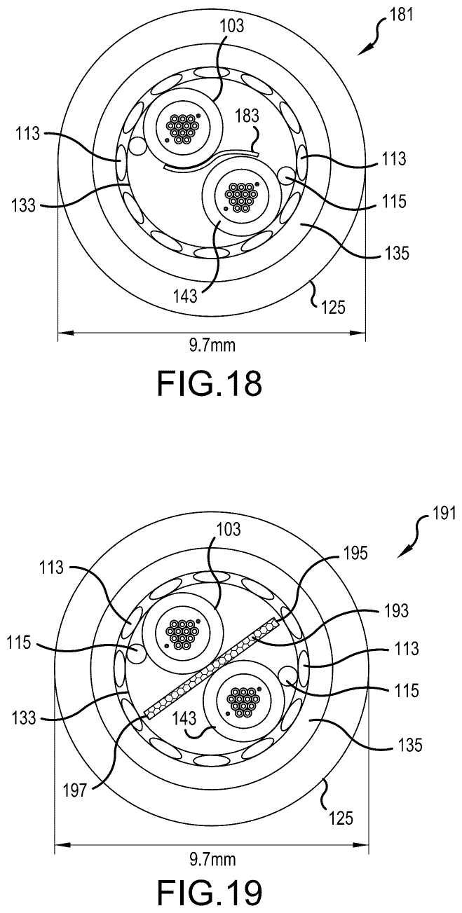

FIG. 18 depicts an end view of a seventh cable 181, in accordance with the present invention. The seventh cable 181 is similar to the embodiment of FIG. 17 and has first and second buffer tubes 103 and 143 stranded together. Of particular note, is that a flexible tape 183, such as a mylar tape, is interposed between the first and second buffer tubes 103 and 143. The flexible tape 183 may optionally be layered with water-blocking dry powder, such as super absorbent powder (SAP). In a preferred embodiment, the flexible tape 183 is formed by a combination of materials including at least one of a water blocking tape, a multiple layer tape, a mylar tape; a tape having water-blocking powders embedded therein and a tape having water-blocking powders applied thereto.

E-glass strength members 113 and may be placed on an outer surface of an optional core wrap 133, which may be formed of a paper or polymer material. The e-glass strength members 113 are also in abutment with an inner surface of an armor layer 135, as in FIGS. 10 and 15.

FIG. 19 depicts an end view of an eighth cable 191, in accordance with the present invention. The eighth cable 191 is similar to the embodiment of FIG. 18 and has first and second buffer tubes 103 and 143 stranded together. Of particular note, is that the flexible tape 183 has been replaced with a rigid tape 193 formed by a FRP material, such as a GRP material. The rigid tape 193 serves as the dielectric strength member and has a rectangular cross-section having a first short end 195 and an opposite, second short end 197. The first buffer tube 103 abuts the dielectric strength member proximate a midpoint of a first long side of the dielectric strength member and the second buffer tube 143 the dielectric strength member proximate a midpoint of an opposite second long side of the dielectric strength member.

In the embodiment of FIG. 19, the first and second short ends 195 and 197 of the rigid tape 193 are spaced apart to reside at about the same twist orbit radius as the first and second buffer tubes 103 and 143. In other words, the distance between the first and second short ends 195 and 197 of the rigid tape 193 is approximately equal to the diameter of the first buffer tube 103 plus the diameter of the second buffer tube 143 plus the thickness of the rigid tape 193 between the first and second long sides of the rigid tape 193. By this arrangement, the armor layer 135 has four support points. If the length of the rigid tape 193 were shorter, the armor layer 135 would have but two support points (provided by the first and second buffer tubes 103 and 143) and the outer surface of the outer jacket 125 would tend to assume an undesirable, oval cross-sectional shape.

In FIG. 19, the first and second buffer tubes 103 and 143, with the rigid tape 193 therebetween, may be stranded in a single direction, i.e., not SZ stranded. To control stress on the fibers within the buffer tubes, the buffer tubes are served using a back twist payoff. The target strand lay length may be set to traditional lay length like three to six inches, but more preferably is set to another value, such as more than ten inches, e.g., more than fifteen inches, like 18 to 24 inches. The longer helical lay length would make a mid-span access easier. In a preferred embodiment, the rigid tape 193 would be initially extruded at the targeted lay length and shipped to the cable manufacturer on a reel or spool.

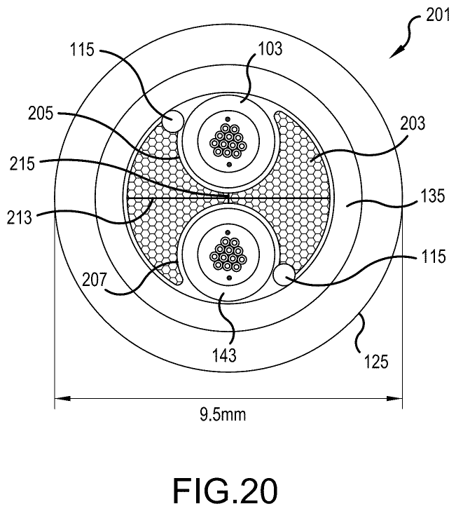

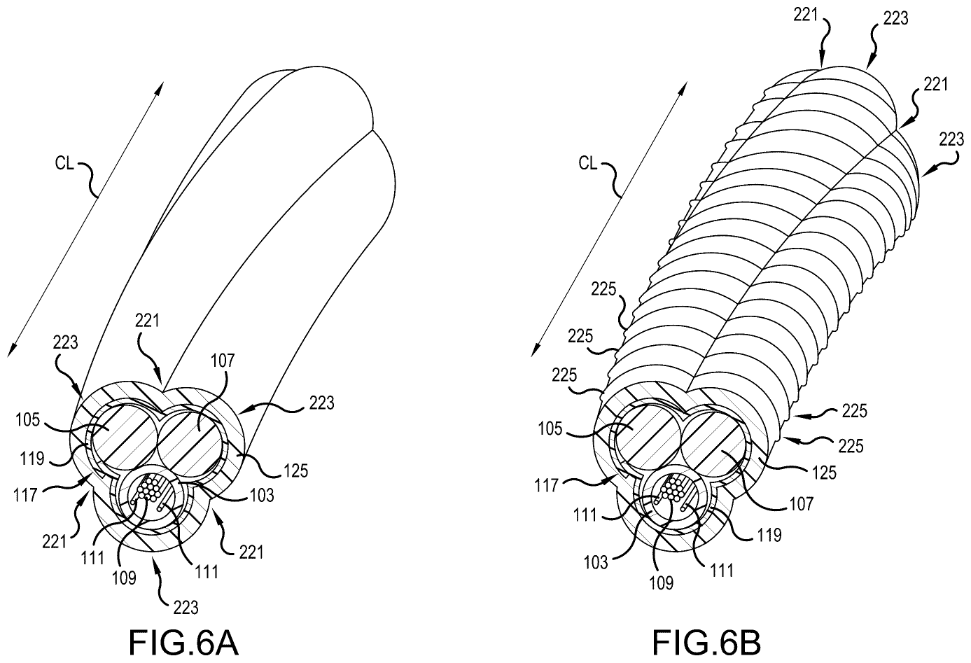

FIG. 20 depicts an end view of a ninth cable 201, in accordance with the present invention. The ninth cable 201 is similar to the embodiment of FIG. 19 and has first and second buffer tubes 103 and 143 stranded together. Of particular note, is that the rigid tape 193 has been replaced with a rigid member 203 having a double-sided axe head shape. The rigid member 203 is formed by a FRP material, such as a GRP material.

In FIG. 12, the optical cable 201 includes the first buffer tube 103 surrounding at least one optical fiber, such as twelve, and the second buffer tube 143 surrounding at least one optical fiber, such as twelve. The second buffer tube 143 may be replaced by a filler rod 163, if desired.

The rigid member 203 resides between the first and second buffer tubes 103 and 143. A central axis of the rigid member 203 coincides with a central axis of the optical cable 201. The rigid member 203 has a cross-sectional shape with a first recess 205 formed on a first side (top side in FIG. 20) and a second recess 207 formed on an opposite, second side (bottom side in FIG. 20). The first and second recesses 205 and 207 have a same size and shape, so as to accommodate one of the first or second buffer tubes 103 or 143.

More particularly, the rigid member 203 has a cross sectional shape defined by a major axis 213 extending between first and second opposed side edges (horizontal in FIG. 20) and a minor axis 215 extending between third and fourth opposed side edges (vertical in FIG. 20). The minor axis 215 is shorter than the major axis 213 and intersects the middle of the major axis 213 at a ninety-degree angle. In a preferred embodiment, the major axis 213 is at least eight times longer than the minor axis 215. The first and second side edges follow arc portions of a first circular circumference, have a diameter equal to the major axis 213. The third and fourth side edges include the first and second recesses 205 and 207, each having a same size and shape. The first and second recesses 205 and 207 follow arc portions of second and third circular circumferences, respectively, which are approximately the same or slightly larger than a diameter of the first and second buffer tubes 103 and 143, respectively.

The rigid member 203 may be formed of an extruded material, wherein the first and second recesses 205 and 207 twist around a central axis of the rigid member 203 along a length of the rigid member 203. For example, the first and second recesses 205 and 207 twist around the central axis of the dielectric strength member for at least four revolutions in a clockwise direction then twist around said central axis of the dielectric strength member for at least four revolutions in a counterclockwise direction. As such, the first and second buffer tubes 103 and 143, when later placed in to the first and second recesses 205 and 207, are stranded about the rigid member 203 in an S-Z patter as parts of a cable core.

In a preferred process for forming the rigid member 203, the twist of the first and second recesses 205 and 207 around the central axis of the rigid member 203 in the clockwise direction is achieved by rotating an extrusion die forming the rigid member 203 in a clockwise direction for at least four revolutions at a first rotational speed as a material passes through the extrusion die. The process then uniformly and slowly decreases the clockwise rotation of the extrusion die to a stop and immediately, uniformly and slowly accelerates a counterclockwise rotation of the extrusion die up to the first rotational speed. Next, the process uniformly and smoothly slows the counterclockwise rotation of the extrusion die to a stop and immediately, uniformly and slowly accelerates a clockwise rotation of the extrusion die up to the first rotational speed, with the process repeating as a length of the rigid member 203 is formed.

The rigid member 203 itself is not being twisted. Rather, the first and second recesses 205 and 207 on the outside of the rigid member 203 are being formed to spiral in a first direction for several turns and then spiral in the opposite, second direction for several turns. This provides a rigid member 203 which is can guide “linearly-fed” buffer tubes into a desired S-Z stranding pattern on the outside of a rigid member 203. The first and second recesses 205 and 207 may alternatively be formed in a consistent helical pattern on the outside of the rigid member 203.

An extruded length of the rigid member 203 exceeds five hundred feet and the rigid member 203 is taken up on a storage reel or spool to be shipped to a cable manufacturing plant. In practice, the rigid member 203 may be several thousand feet to one hundred thousand feet or more on the storage reel or spool.

With the cables of the present invention, the pull force needed to pull the cable through a conduit is greatly reduced due to the smaller outer diameter and weight of the cable. Also, if the cables of the present invention are installed in an outside environment, the wind and ice loads on the cable and its supporting structures are greatly reduced due to the smaller diameters of the cables. For example, with the embodiment of FIG. 2, with first and second strength members 105 and 107 and one buffer tube 103, eight hundred feet of cable 101 could be pulled through a 1¼ inch conduit with only 34 pounds of force. The lower pulling force not only eases the burden on the installer, but also makes it less likely that the cable 101 will be damaged during installation.

The cables of the present invention exhibit better bend performance, which allows for tighter bends in the cables during installation. Currently, installers use a twelve-inch diameter guide wheel at a bend and do not bend the cable more than ninety degrees. The new cables can be installed with a three-inch wheel and may be bent more than one hundred twenty degrees. For example, in a test installation, the cable of FIG. 2 was pulled a distance of 2 miles and bent one hundred thirty-six degrees about a three-inch diameter guide wheel with no derogations to the optical signal performance.

The cables of the present invention exhibit better crush resistance. The smaller diameter of the outer jacket 125 in FIGS. 2-10 translates into a smaller diameter for the inner corrugated armor layer 135. The smaller the diameter of the armor layer 135, the more strength that the armor layer 135 exhibits to support a crushing force. Further, even if the armor layer 135 is crushed, it is believed that the inner design of the cable assists in preventing damage to the optical fibers within the buffer tube(s). In one test, a truck weighting about 11,000 pounds drove over a test length of the cable 101A of FIG. 6 twice on a path of hard-packed dirt and gravel, and the crushing force did not break the optical fibers 109 within the buffer tube 103, as verified by an optical time-domain reflectometer (OTDR) test signal being monitored as the cable 101 was crushed by the truck.

It is believed that the improved crush resistance and the improved bend performance were due to a physical shifting of cable components within the cable core at the crush or bend locations. In other words, the buffer tube 103 slid off of the first and second strength member 105 and 107 to assume a more side-by-side relationship at a tight bend or crushing point of contact. In the prior art (FIG. 1A), the GRP rod 23 is captured in the middle of the cable 20 and the buffer tubes 21 are captured in abutment on the outer walls of the GRP rod 23 by binders. Due to the binders and abutments to adjacent buffer tubes 21 and/or filler rods, there is no possibility for a buffer tube 21 to slide off of the GRP rod 23. Hence, the buffer tube 21 is crushed into the rigid GRP rod 23 and the optical fibers 22 therein are crush into a micro-bend or broken against the GRP rod 23 when an excess force is applied to the side of the cable 20, e.g., when a truck is driven over the cable 20.

In the embodiments of the present invention, helical stranding is preferred over S-Z stranding. Stranding in a S-Z pattern typically require binders 35 and/or 37, as shown in FIG. 1B. Such binders 35 and/or 37 add costs, increase the size, slow the manufacturing speed, and may also lead to damage of the buffer tube(s) and the optical fibers therein if the cable is subjected to a lateral crushing force.

In the prior art of FIGS. 1A and 1B, the buffer tube(s) is/are traveling in a helix about a center axis, which passes through a center line of the centrally located, strength member. Where S-Z stranding is used with a lay length of about 3.0 to 3.5 inches, this travel path translates into an optical fiber within a buffer tube having a length of about 1,018 feet for every 1,000 feet of cable. In the cables of the present invention, both the central strength member(s) and the buffer tube(s) travel in a helix about a center line which is between the center line of the strength member and a center line of the buffer tube. For the embodiment of FIG. 2 with a lay length of about 7.5 to 8.0 inches, this travel path translates into an optical fiber traveling about 1,001 feet (actually about 1,000 feet and six inches) in a 1,000 feet long cable.

Carrying the strength member in a helix with a long lay length has numerous advantages in addition to the obvious cost savings of using less optical fiber length within a same length of cable. When an optical channel within a cable is not functioning properly, a technician typically uses an optical time-domain reflectometer (OTDR) attached to one end of the cable to locate the point where the optical channel is failing. The OTDR sends signals out though the optical fibers, and the signal partially reflects at a micro-bend or break in an optical fiber. The timing of the receipt of the reflection is indicative of the distance between the OTDR and the location of the optical fiber damage.

With the cables of the present invention, the distance shown on the OTDR can be used directly to find the damaged section within the cable. For example, if the OTDR reads 735 feet, the technician can look at the distance marking on the cable jacket at the OTDR location, e.g., 0045 feet, and then proceed to the find the cable location which is 735 feet way, i.e., the cable location where the distance marking on the jacket reads 0780 feet. That location will be within 1 foot of the damaged optical fiber. At that location, the technician removes a few feet of the cable jacket and preforms a repair slicing operation. In the prior art, the damaged location of the cable had to be calculated using an algorithm which included variables like the lay length, central strength member diameter, etc. to arrive at the distance marking on the cable jacket where a repair was needed. In the prior art, finding the repair location by simply adding the OTDR distance to the distance marking on the cable jacket at the OTDR would land the technician many feet away from the actual damaged location, such as more than 10 feet away.

Water blocking materials may be added to the various embodiments of the invention. Water blocking threads, yarns or tapes, such as those sold under the trademark SWELLCOAT™, manufactured by FIBER-LINE®, may optionally be included to block water flow into the cable core and/or buffer tubes. Such threads, yards or tapes are capable of absorbing a water weight up to 100× the weight of the dry thread, yarn or tape. For example, threads, yarns or tapes with water swellable powder may be wrapped around or placed alongside the cable core to prevent water migration. Alternatively, the threads or yarns may be added elements to be stranded along with the cable core. A tape or core wrap 133 with water swellable powder may be applied over the stranded core. In a preferred embodiment, water swellable powder is applied directly to the strength member(s), the buffer tube(s), any filler rod, and/or the inside of the armor layer, such that the use of additional threads, yarns and tapes may be avoided. In the embodiment of FIG. 12, the water-blocking or water-absorbing gel 145 is added to the cable core, such a water-blocking or water-absorbing gel 145 may be used in any of the embodiments of the present invention.

In the various embodiments of the present invention, the buffer tubes are of a loose tube design for accommodating twelve optical fibers, which are disconnected, i.e., loose. Alternatively, the optical fibers may optionally be ribbonized, e.g., connected to each other by a rolled or collapsible ribbon. More or fewer optical fibers may be included in each buffer tube as well, such as two bundles of twelve fibers each in each buffer tube.

In the various embodiments of the present invention, the buffer tubes, optical fibers, strength members and any other members of the cable core, which are to be stranded, may have a back twist applied thereto prior to the stranding operation. The back twisted may be applied inline during the manufacturing process, just prior to the stranding operation. Alternatively, the element may have been previously back twisted and stored on a reel or spool prior to being brought to the cable manufacturing machine. The back twist of the stranded elements can assist a technician working on a mid-span access. The back twist relieves some or all of the natural tendency of the cable element to spring-back and tangle or create a nest when the element is cut at a mid-span access.

In the various embodiments of the present invention, the optical fibers may all be of a single mode type, may all be of a multimode type, or may be a mixture of the two types. The optical fibers may all be a same diameter or may be of different diameters such as 200 um, 250 um, or other diameters.

In the various embodiments of the present invention, fiberglass strength members which are depicted with an oval cross-sectional shape may be formed of a same or similar material as the strength members with a circular cross-sectional shape. However, in a preferred embodiment the fiberglass strength members which are depicted with an oval cross-sectional shape are formed of e-glass, e.g., a polyester material with embedded reinforcement fibers. The initial or final cross-sectional shape of these smaller strength members may be more oval or even rectangular. The polyester e-glass strength members 113 may each have a cross-sectional area less than 25% of the cross-sectional area of the first buffer tube 103. Water-blocking powder could also be applied to these smaller strength members.

In all of the embodiments with two buffer tubes, the second buffer tube may be replaced by a filler rod, such as a rod formed with a same diameter as the first buffer tube and formed of a solid dielectric material, which will allow the cable core to have a same shape as shown in the various embodiments. The remaining, first buffer tube may continue to include twelve optical fibers, such that the cable is a twelve-fiber optical cable. Of course, more or fewer optical fibers may be included, as previously discussed.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

We claim:

1. An optical cable comprising:
a first buffer tube surrounding at least one optical fiber;
a first dielectric strength member having embedded reinforcement material therein, wherein said first buffer tube and said first dielectric strength member are stranded together as parts of a cable core, such that said first dielectric strength member follows a helical path over a length of said optical cable; and
an outer jacket surrounding said cable core, wherein an outer surface of said outer jacket has a diameter of less than 0.45 inches.

2. The optical cable according to claim 1, wherein said first dielectric strength member has a tensile strength greater than 50 pounds, such that less than 50 pounds of tensile force will not cause said dielectric strength member to break or elongate by more than 1%.

3. The optical cable according to claim 1, further comprising:
a second dielectric strength member having embedded reinforcement material therein, wherein said first buffer tube, said first dielectric strength member and said second dielectric strength member are stranded together as parts of said cable core, such that said first and second dielectric strength members and said first buffer tube follow helical paths over a length of said optical cable.

4. The optical cable according to claim 3, wherein said first buffer tube is back twisted prior to being stranded as part of said cable core.

5. The optical cable according to claim 1, further comprising:
a second buffer tube surrounding at least one optical fiber, wherein said first buffer tube, said second buffer tube and said first dielectric strength member are stranded together as parts of said cable core, such that said first dielectric strength member and said first and second buffer tubes follow a helical path over a length of said optical cable.

6. The optical cable according to claim 5, further comprising:
a second dielectric strength member having embedded reinforcement material therein, wherein said first buffer tube, said second buffer tube, said first dielectric strength member and said second dielectric strength member are stranded together as parts of said cable core, such that said first and second dielectric strength members and said first and second buffer tubes follow helical paths over a length of said optical cable.

7. The optical cable according to claim 5, wherein said first buffer tube and said second buffer tube are back twisted prior to being stranded as parts of said cable core.

8. The optical cable according to claim 1, further comprising:
an armor layer surrounding said cable core, wherein said armor layer is surrounded by said outer jacket.

9. The optical cable according to claim 8, wherein said armor layer is formed by a corrugated metal sheet.

10. The optical cable according to claim 1, wherein said at least one optical fiber includes at least eight optical fibers.

11. The optical cable according to claim 1, wherein an outer surface of said outer jacket has a diameter of about 0.36 inches or less.

12. The optical cable according to claim 11, wherein an outer surface of said outer jacket has a diameter of about 0.30 inches.

13. An optical cable consisting essentially of:
a first buffer tube surrounding at least one optical fiber;
a first strength member;
a second strength member, wherein said first buffer tube, said first strength member and said second strength member are stranded together to form a cable core, such that said first and second strength members and said first buffer tube follow a helical path over a length of said optical cable;
at least one ripcord adjacent to said cable core and/or at least one water blocking element adjacent to, or stranded along with, said cable core;
an armor layer surrounding said cable core and said at least one ripcord and/or at least one water blocking element; and
an outer jacket surrounding said armor layer.

14. The optical cable according claim 13, wherein said first strength member is formed by a dielectric material having embedded reinforcement material therein, and wherein said second strength member is formed by a dielectric material having embedded reinforcement material therein.

15. The optical cable according claim 13, wherein said first strength member is formed by stranded steel wires covered by a polymer upjacket, and wherein said second strength member is formed by stranded steel wires covered by a polymer upjacket.

16. The optical cable according claim 13, wherein said optical cable includes at least one ripcord and includes at least one water blocking element in the form of water blocking threads or yarns, and wherein said water blocking threads or yarns are stranded along with said cable core.

17. The optical cable according claim 13, wherein said first buffer tube is back twisted and includes at least eight optical fibers.

18. An optical cable comprising:
a buffer tube surrounding a plurality of optical fibers;
a first dielectric strength member having embedded reinforcement material therein;
a second dielectric strength member having embedded reinforcement material therein, wherein said buffer tube, said first dielectric strength member and said second dielectric strength member are stranded together as parts of a cable core, such that said first dielectric strength member, said second dielectric strength member and said buffer tube follow a helical path over a length of said optical cable;
an armor layer surrounding said cable core; and
an outer jacket surrounding said armor layer, wherein an outer surface of said outer jacket includes three peaks overlying radially outmost portions of said buffer tube, said first dielectric strength member and said second dielectric strength member, and wherein said outer surface of said outer jacket also includes three valleys following helical within the interstices between said buffer tube, said first dielectric strength member and said second dielectric strength member.

19. The optical cable according claim 18, wherein said armor layer is corrugated and wherein said outer surface of said outer jacket includes ridges which overlie ridges of said corrugated armor layer.

20. The optical cable according claim 19, wherein said ridges as substantially annual and intersect a cable length of said cable approximately perpendicularly, and wherein said peaks extend substantially parallel to said cable length.
